(19) United States
(12) Patent Application Publication
(10) Pub. No.: US 2020/0244808 A1
(43) Pub. Date: Jul. 30, 2020

(54) Automatic Number Identification-based Predictive Routing System and Method

(71) Applicant: 46 Labs, L.L.C., Edmond, OK (US)

(72) Inventor: Dean Hansen, Ottawa (CA)

(21) Appl. No.: 16/773,896

(22) Filed: Jan. 27, 2020

Related U.S. Application Data
(60) Provisional application No. 62/797,117, filed on Jan. 25, 2019.

(51) Int. Cl. H04M 3/523; H04M 3/42; H04M 3/51

(52) U.S. Cl. CPC H04M 3/5238; H04M 3/5237; H04M 3/5191; H04M 3/5175; H04M 3/42068

(57) ABSTRACT

A system and method for routing calls using predictive analysis of incoming calls. A router receives incoming calls and processes the calls to generate call data records. An optimizer processes the call data records to generate a menu of prioritized call rules and a predictive call routing table. A predictive routing cache communicates the predictive routing table to the router. The router uses the routing table to alter a set of call rules used to optimize the routing of calls.

### CROSS-REFERENCE TO RELATED APPLICATION

This application claims the benefit of provisional patent application Ser. No. 62/797,117, filed on Jan. 25, 2019, the entire contents of which are incorporated herein by reference.

### FIELD OF THE INVENTION

The present invention relates generally to telecommunications, and particularly to a system and method for improving telephone call routing for a telecommunications provider.

### SUMMARY OF THE INVENTION

The present invention is directed to a method comprising providing a processor programmed to extract a plurality of call detail records for incoming calls that utilize a router. The call detail records are processed to determine a predicted routing value. Routing of at least a portion of a plurality of outbound calls from the router is altered based on the predicted routing value to alter the real-time profitability of a subscriber.

The invention is further directed to a method for providing a processor programmed to extract a plurality of call detail records for calls that utilize a router. The plurality of call detail records for a plurality of automatic number identification and underlying carrier pairs are stored and then retrieved and processed to determine a predicted routing value for each of the plurality of pairs. New call attempts are routed using the predicted routing value to determine which underlying carrier to attempt and in which order.

The present invention is also directed to a system comprising a router, a data store, an optimizer, and a predictive routing cache. The router is programmed to receive a plurality of incoming calls and process the plurality of calls to generate a plurality of call data records. The data store is operatively connected to the router to receive and store the plurality of call data records. The optimizer is operatively connected to the data store to retrieve the call data records from the data store and programmed to process the call data to generate prioritized call rules and a predictive routing table. The predictive routing cache is connected to the optimizer to receive the predictive routing table and communicate the predictive routing table to the router to alter a set of call rules the router uses to optimize the routing of calls.

### BRIEF DESCRIPTION OF THE DRAWINGS

FIG. 1 is a diagrammatic representation of a predictive routing telecommunications system.

FIG. 2 is a diagrammatic representation of a process for use of a predictive routing value optimizer.

### DESCRIPTION

Current voice switching platforms use a Least Cost Router (“LCR”) to make routing decisions when a voice call attempt is made. Least cost routing is a method for selecting the path of outbound and inbound communications traffic based on cost. An LCR may be used to automatically and periodically select the least cost route from several carriers. However, the LCR method limits the ability to connect a call attempt. This limit is present because the router is making routing decisions based primarily on the pricing of the Underlying Carriers (“ULC”), and not based on performance during specific hours of the day.

In the present invention LCR is not used as the sole basis for routing calls. Rather, calls are routed based on a Predicted Routing Value. Accordingly, the system and method of the present invention measures the performance of Automatic Number Identifications (“ANI”) as they relate to each ULC at unique time intervals. ANI is a common feature in the telecom industry for determining the telephone number of an origination call. ANI is comprised of information digits that identify the service of the origin and the billing number of the origin.

Using ANI performance measurements, a router makes routing decisions based on a prediction of which ULCs are most likely to connect a call attempt in order of relative profitability rather than based upon the least cost. Relative profitability is determined by a weighted value using Answer Seizure Ratio (“ASR”), Average Call Duration (“ACD”) and Profit Per Minute (“PPM”) of the ANI relative to the ULCs for the selected time interval. This weighted value is the Predicted Routing Value (“PRV”).

The ANI-based Predictive Routing system and method measures the performance of millions of call attempts per minute in a near real-time to a real-time environment. A predictive router calculates a PRV of each ANI relative to each underlying carrier for each ANI during an interval of time. In a preferred embodiment an interval of sixty (60) seconds may be used at the chosen interval of time.

As an example, if 100,000 ANIs are observed between 12:00 PM and 12:01 PM with an average of 10 carriers in route per ANI then there will be 1,000,000 calculations performed for that minute of the day; one calculation per ANI/ULC combination. One skilled in the art will appreciate that the ANIs and the underlying carriers will perform differently during different time intervals. Therefore, it is important to calculate the Predicted Routing Value in real-time or near real-time.

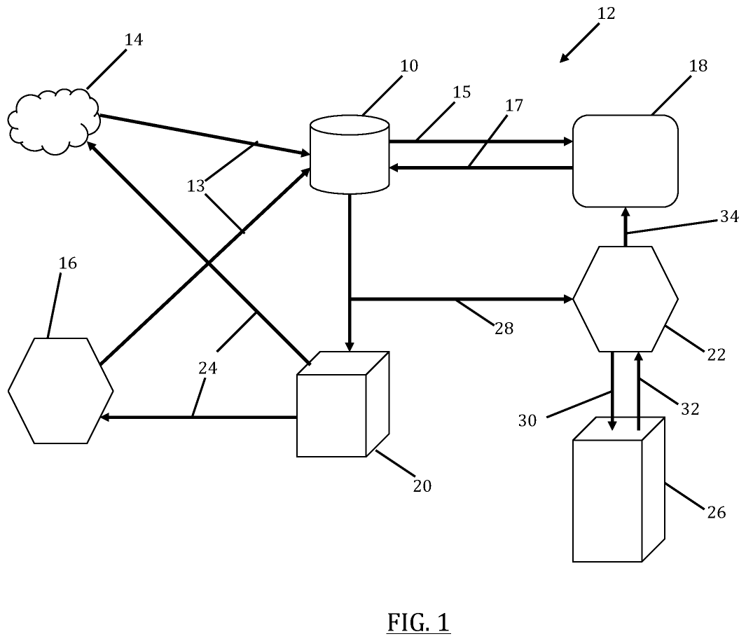

When one or multiple new call attempts are made, a Predictive Router 10 (FIG. 1) will use the most recent Predicted Routing Values to determine which underlying carriers it will attempt and in what order. In order to use the most current and relevant PRV, the system will refresh the PRV record values on a predetermined time schedule, preferably every sixty (60) seconds. The present invention optimizes both the odds of completing a call attempt as well as the profitability of the attempt. As a result, the ANI-based Predictive Router of the present invention completes more call attempts with less capacity and at higher profitability.

As discussed above, the system and method of the present invention makes use of PRV records to make routing decisions. The PRV is a weighted combination of several call factors. For example, Answer Seizure Ratio, Average Call Duration and Profit Per Minute may be used to calculate the PRV. The PRV is calculated for each ANI and ULC combination that attempted a call over the selected time interval.

In order to establish a PRV, a user can set a default configuration, such as equal weighting, to balance the maximization of switch/carrier capacity along with maximizing profit. Alternatively, the user can customize the weight given to each value based on its priorities and profit motives to influence routing behavior.

For example, if a user recognizes it has limited carrier capacity, it can apply increased weighting value on performance (ASR, ACD) to improve network utilization and influence its carriers to provide acceptable capacity at acceptable rates.

In the inverse situation, wherein a user recognizes it has excess network capacity, it may increase the weighting value of profit (PPM) in order to improve overall profit at the expense of additional network resources.

The configurable weighting values allow the user to tune the PRV value to suit its specific business needs. Permitting the user control over variable weighting can be implemented in a user interface. The user interface may comprise a dynamic web-based application configured to receive input from the user regarding PRV weighting control. The user interface may also display the user's performance data, including real-time profitability. The user input may be received using a variety of methods including slider buttons, direct number entry, virtual dials or any number of manipulators that can represent a percentage weighting scale.

Turning now to FIG. 1, the ANI-based predictive routing system 12 of the present invention is shown therein. As shown therein, inbound calls 13 are received by router 12 from a call source. The call sources shown in FIG. 1 comprise the internet 14 or a cloud private network connection 16. One skilled in the art will appreciate that other sources of inbound calls may be utilized in the present invention.

Upon receiving the inbound call attempt(s), the router 10 queries a predicted routing cache 18 for the ANI in the call attempt in a routing cache ANI Look-up command 15. The predicted routing cache 18 returns a list of optimized ULCs 17 to the router 10. The list of ULCs is arranged in the order of the highest predicted routing value. The router 10 then attempts each ULC in order of the list returned from the predicted routing cache 18. The router 10 communicates the call routing selection to a switch 20. Each outbound call communicated from router 10 to the switch 20 is recorded and stored in a data store 22. The switch 20 generates optimized outbound calls 24 that are transmitted to their destination via the Internet 14 or cloud private network connection 16.

Each recorded outbound call 28 comprises raw call data that is stored in the data store 22. The raw call data may comprise call time, duration, completion status, source number, destination number, routing path, and call type. An ANFULC Optimizer 26 retrieves the raw call data 30 periodically from the data source 22. The optimizer 26 processes the call data to generate updated prioritized call rules 32 that are transmitted to the data store 22 and used to generate updated predictive routing tables. The updated tables are communicated 34 to and stored by the predictive routing cache 18 until replaced by a newly updated table. The tables are comprised of call rules that are used by the predictive routing cache 18 and the router 10 to optimize ULCs response.

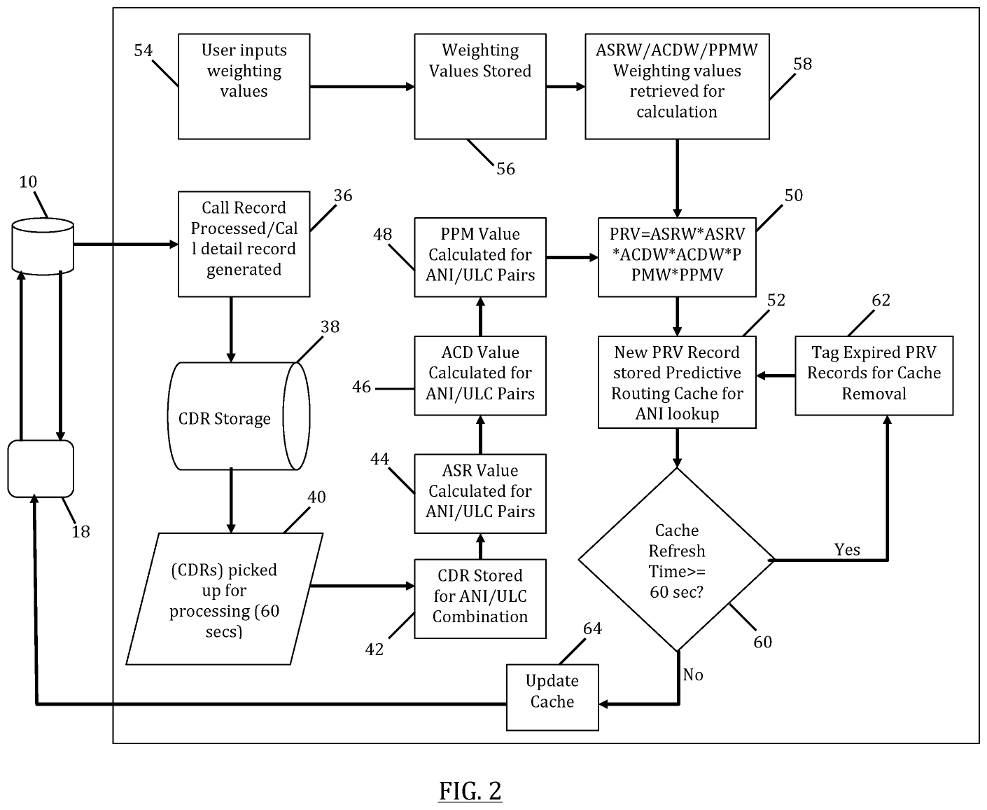

With reference now to FIG. 2, the predictive routing value optimizer process will be described. Calls sent to the router 10 are recorded and processed (36) to generate the call detail records (“CDR”). Each CDR is stored in a CDR storage memory device 38. The stored CDRs are culled for processing every 60 seconds (40). The CDRs are stored for every ANFULC combination (42). The records are then processed to determine an ASR value for every ANFULC combination (44). Next, an ACD value is calculated for each ANI/ULC combination (46). At the next step a PPM value is calculated for each ANI/ULC combination (48). Using the updated or new ASR, ACD, and PPM the PRV is calculated (50). The PRV is transmitted (52) to the predictive routing cache 18.

The user may input or update desired weighting values for the ASR, ACD, and PPM (54). These weighting values may be used on a global basis or per ANI. The weighting values are stored (56) and retrieved (58) when needed for calculations. The PRV is calculated for each ANFULC combination as follows:

PRV=(@ASR*@ASRWeightingValue)*(@ACD*@ACDWeightingValue)*(@PPM*@PPMWeightingValue).

The new PRV value is stored (52) by the predictive routing cache for ANI lookup. At the next step the cache refresh timer is queried (60). If the timer has expired the expired PRV records are tagged for removal (62). If the cache refresh timer has not expired the cache is updated (64) with the new PRV records which are used to optimize future call attempts.

Although the present invention has been described with respect to a preferred embodiment, various changes and modifications may be suggested to one skilled in the art, and it is intended that the present invention encompass such changes and modifications as fall within the scope of this disclosure.

What is claimed is:

1. A method comprising:
providing a processor programmed to extract a plurality of call detail records for incoming calls that utilize a router;
processing the call detail records to determine a predicted routing value; and
altering a routing of at least a portion of a plurality of outbound calls from the router, based on the predicted routing value, to alter real-time profitability of a subscriber.

2. The method of claim 1 further comprising extracting the call detail records at a predetermined interval of time.

3. The method of claim 2 wherein each call detail record comprises an automatic number identification and underlying carrier combination.

4. The method of claim 1 further comprising hosting a secure website to display the real-time performance data and real-time profitability of the subscriber.

5. The method of claim 3 wherein the predicted routing value comprises an average call duration value, a profit per minute value, and answer seizure ratio of the automatic number identification relative to the underlying carrier.

6. A method comprising:
providing a processor programmed to extract a plurality of call detail records for calls that utilize a router;
storing the plurality of call detail records for a plurality of automatic number identification and underlying carrier pairs;
retrieving the pairs and processing each pair to determine a predicted routing value for each of the plurality of pairs; and
routing new call attempts using the predicted routing value to determine which underlying carrier to attempt and in which order.

7. The method of claim 6 further comprising refreshing the predicted routing value at predetermined intervals.

8. The method of claim 7 wherein the predetermined interval is one minute.

9. The method of claim 6 wherein the predicted routing value comprises a weighted combination of an answer seizure ratio, average call duration, and profit per minute.

10. The method of claim 9 further comprising applying equal weight to the answer seizure ratio, average call duration, and profit per minute.

11. The method of claim 9 further comprising applying unequal weight to profit per minute value to increase profitability.

12. A system comprising:
a router programmed to receive a plurality of incoming calls and process the plurality of calls to generate a plurality of call data records;
a data store operatively connected to the router to receive and store the plurality of call data records;
an optimizer is operatively connected to the data store to retrieve the call data records from the data store and programmed to process the call data to generate prioritized call rules and a predictive routing table; and
a predictive routing cache connected to the optimizer to receive the predictive routing table and communicate the predictive routing table to the router to alter a set of call rules the router uses to optimize the routing of calls.

13. The system of claim 12 further comprising a switch configured to receive call routing selection instructions from the router and to transmit outbound calls.

14. The system of claim 12 wherein the predictive routing cache stores the predictive routing table for use by the router.

15. The system of claim 12 wherein the predictive routing table comprises a predicted routing value for an automatic number identification for an underlying carrier.

16. The system of claim 15 wherein the predicted routing value is determined using an answer seizure ratio, average call duration, and profit per minute.

17. The system of claim 12 wherein the predictive routing table comprises a plurality of predicted routing values, each predicted routing value relating to an automatic number identification.

18. The system of claim 12 wherein the optimizer generates an updated predictive routing table once per minute.

19. The system of claim 18 wherein the predictive routing cache updates the predictive routing table once per minute.
